(19) United States
(12) Patent Application Publication
(10) Pub. No.: US 2019/0312864 A1
(43) Pub. Date: Oct. 10, 2019

(54) METHOD AND APPARATUS FOR ESTABLISHING ASSOCIATION BETWEEN DEVICES

(71) Applicant: Lenovo (Beijing) Co., Ltd., Beijing (CN)

(72) Inventor: Weili YANG, Beijing (CN)

(21) Appl. No.: 16/372,889

(22) Filed: Apr. 2, 2019

(30) Foreign Application Priority Data
Apr. 4, 2018 (CN) 201810298217.3

(51) Int. Cl. H04L 29/06; H04W 76/14; H04W 12/06

(52) U.S. Cl. CPC H04L 63/0861; H04W 12/06; H04W 76/14

(57) ABSTRACT

A method and an apparatus for establishing association between devices are provided. The method includes: obtaining identity information of a current user, and in response to the identity information satisfying a pre-configured condition, establishing an association with a mobile terminal associated with the identity information. The identity information includes biological unique information.

### CROSS-REFERENCES TO RELATED APPLICATIONS

This application claims the priority of Chinese Patent Application No. 201810298217.3, filed on Apr. 4, 2018, the entire content of which is incorporated herein by reference.

### FIELD OF THE DISCLOSURE

The present disclosure generally relates to the field of electronic products and, more particularly, relates to a method and an apparatus for establishing association between devices.

### BACKGROUND

Compared with computers, users often like to use mobile terminals because they are small, portable, and full of features. Exchanging data between a mobile terminal and a computer is a common scenario in everyday applications.

Currently, the mobile terminal exchanges data with the computer primarily based on a one-to-one transmission mode. That is, the mobile terminal connects with the computer through a wireline or wireless communication connection and shares the data with the computer.

A connection process primarily involves a manual entry of identity authentication information, which is cumbersome and error-prone.

The disclosed method and apparatus for establishing association between devices are directed to solve one or more problems set forth above and other problems in the art.

### BRIEF SUMMARY OF THE DISCLOSURE

One aspect of the present disclosure provides a method. The method includes: obtaining identity information of a current user; and in response to the identity information satisfying a pre-configured condition, establishing an association with a mobile terminal associated with the identity information. The identity information includes biological unique information.

Another aspect of the present disclosure provides an apparatus. The apparatus includes: an acquisition device for obtaining identity information of a current user; and an association device for establishing an association with a mobile terminal associated with the identity information in response to the identity information satisfying a pre-configured condition. The identity information includes biological unique information.

Other aspects of the present disclosure can be understood by those skilled in the art in light of the description, the claims, and the drawings of the present disclosure.

### BRIEF DESCRIPTION OF THE DRAWINGS

To more clearly illustrate the technical solution in the present disclosure, the accompanying drawings used in the description of the disclosed embodiments are briefly described hereinafter. Obviously, the drawings described below are merely some embodiments of the present disclosure. Other drawings may be derived from such drawings by a person with ordinary skill in the art without creative efforts and may be encompassed in the present disclosure.

FIG. 1 illustrates a flow chart of an example of a method of establishing association between devices according to some embodiments of the present disclosure;

FIG. 2 illustrates a block diagram of an example of an apparatus for establishing association between devices according to some embodiments of the present disclosure;

FIG. 3 illustrates a flow chart of another example of a method of establishing association between devices according to some embodiments of the present disclosure; and

FIG. 4 illustrates a block diagram of another example of an apparatus for establishing association between devices according to some embodiments of the present disclosure.

### DETAILED DESCRIPTION

To make the foregoing objectives, features and advantages of the present disclosure clearer and more understandable, the present disclosure will be further described with reference to the accompanying drawings and embodiments. However, disclosed embodiments may be embodied in various forms and should not be construed as limited to the embodiments set forth herein. Rather, these embodiments are provided to fully convey the thorough and complete concepts of the disclosed embodiments to those skilled in the art.

The present disclosure provides a method for establishing association between devices. Examples of the method are described in detail as follows.

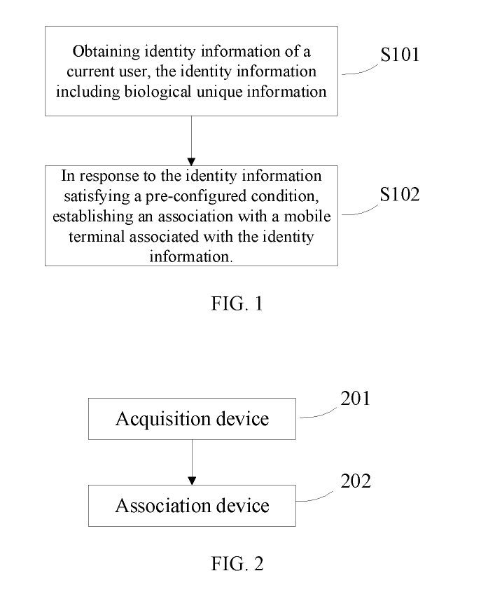

FIG. 1 illustrates a flow chart of an example of a method of establishing association between devices according to some embodiments of the present disclosure.

As shown in FIG. 1, identity information of a current user is obtained (S101), where the identity information includes biological unique information.

The identity information may include, but is not limited to, fingerprint information, face information, and iris information, etc.

Obtaining the identity information of the current user may refer to using a retrieving device of an apparatus to obtain the identity information of the current user, for example, using a fingerprint input device of a notebook computer to obtain the identity information of the current user.

In response to the identity information satisfying a pre-configured condition, an association with a mobile terminal associated with the identity information is established (S102).

Establishing the association with the mobile terminal associated with the identity information may further include the following.

The identity information is used to obtain information of the mobile terminal associated with the identity information (S102-1).

The identity information that biologically identifies a unique individual and the information of the mobile terminal associated with the identity information may often be stored in a data set.

The data set, also known as dataset, data corpus, and data stock, is a collection of data and includes one or more data tables.

The information of the mobile terminal is information that establishes the association with the mobile terminal and includes one or more of: information that unlocks the mobile terminal, information that allows the apparatus to access to the mobile terminal, or information that establishes a connection with the mobile terminal.

The using of the identity information to obtain the information of the mobile terminal associated with the identity information may include querying the identity information stored in the data set and obtaining the information of the mobile terminal associated with the identity information from the data set. For example, after an application program of a notebook computer uses a fingerprint input device thereof to obtain fingerprint information of a user, a corresponding fingerprint data set in a database may be queried for a record matching the inputted fingerprint information, and mobile phone information associated with the matching record may be obtained through a corresponding fingerprint record in the fingerprint data set. In other words, the fingerprint information that is unique to the user may be used to find the mobile phone information that is unique to the user. The mobile phone information may include information that unlocks the mobile phone, information that allows the notebook computer to access to the mobile phone, and information that establishes a connection with the mobile phone. One fingerprint may be associated with information of one or more mobile phones.

The information of the mobile terminal is used to establish an association with the mobile terminal (S102-2).

The established association with the mobile terminal may include one or more of: unlocking the mobile terminal by the apparatus, allowing the apparatus to access the mobile terminal, or establishing a connection with the mobile terminal.

For example, the notebook computer may use information that establishes a connection with the mobile phone to establish the connection with the mobile phone. The notebook computer may use information that unlocks the mobile phone to unlock the mobile phone. The notebook computer may use information that allows the notebook computer to access the mobile phone to access information of the mobile phone. One fingerprint may be associated with one or more mobile phones.

The connection with the mobile terminal may include a wireless connection or a wireline connection. The wireless connection between the apparatus and the mobile terminal may be preferred. The wireless connection may include a Wi-Fi connection, a Bluetooth connection, an infrared connection, and a mobile communication connection, etc. For example, the notebook computer may connect with the mobile phone through a Wi-Fi connection. Before establishing the connection, the notebook computer may obtain a connection name of the mobile phone. When the mobile phone requires a connection password, the notebook computer may further obtain the connection password of the mobile phone, use the connection password to obtain a connection confirmation from the mobile phone, and establish the connection with the mobile phone.

In one embodiment, after the apparatus establishes the connection with the mobile terminal and before the apparatus unlocks the mobile terminal, the apparatus may obtain open access information for the apparatus from the mobile terminal. For example, after the notebook computer establishes the connection with the mobile phone, the notebook computer may directly send the mobile phone request information for open access to the mobile phone, such as request code and security password. After the mobile phone confirms the request information, the notebook computer may obtain the open access information from the mobile phone.

In another embodiment, after the apparatus establishes connections with a plurality of mobile phones, the apparatus may selectively unlock or request open access to some of the plurality of mobile phones. For example, the notebook computer may establish connections with a plurality of mobile phones, generate a mobile phone connection relationship table, and unlock or request open access to mobile phones of interest through the mobile phone connection relationship table.

In another embodiment, because same identity information is able to be associated with a plurality of mobile terminals, establishing associations of the identity information with the plurality of mobile terminals may further include selecting one or more of the plurality of mobile terminals that are associated with the identity information. For example, a selection box including a list of to-be-connected mobile terminals may be popped up on the notebook computer. After the user selects mobile terminals to be connected and confirms the selection, the notebook computer may establish connections with the selected mobile terminals.

Establishing an association of mobile terminal's identity information with a mobile terminal may include the following.

Association request information is sent to a mobile terminal (S102-2-1).

The association request information may include one or more of: request information that establishes a connection with a mobile terminal, request information that unlocks a mobile terminal, or request information that provides the apparatus open access to a mobile terminal.

Association information returned by the mobile terminal is received (S102-2-2), where the association information is in response to the association request information.

The returned association information may include one or more of: retuned connection information, returned unlocking information, or returned open access information.

The pre-configured condition to be satisfied by the identity information may include one of the following two scenarios. In one scenario, the identity information is the same as a pre-stored identity verification information. In another scenario, a similarity that the identity information matches a pre-stored identity verification information satisfies a pre-configured identity verification condition.

Because the identity information involves various factors, the identity information obtained each time may include uncertain contents. Identifying the identity information primarily involves extracting feature information of the identity information and determining validity of the identity information through identifying the feature information. Identifying the identity information may include the following.

A similarity that the identity information matches a pre-stored identity verification information is obtained (S102-3-1).

Whether the matching similarity satisfies a pre-configured identity verification condition is determined (S102-3-2).

The matching similarity may include a matching number and a matching degree. The matching number may refer to a number of the identity information that matches the pre-stored identity verification information. The matching degree may refer to a ratio of the number of the identity information that matches the pre-stored identity verification information over the total number of the identity information.

The pre-configured identity verification condition may include a second pre-configured passing threshold of the matching number and a second pre-configured passing threshold of the matching degree.

Determining whether the matching similarity satisfies the pre-configured identity verification condition may include one or more of: determining whether the matching number and the matching degree are greater than the pre-configured passing threshold of the matching number and the pre-configured passing threshold of the matching degree respectively, determining whether the matching number is greater than the pre-configured passing threshold of the matching number, or determining whether the matching degree is greater than the pre-configured passing threshold of the matching degree.

The particular values of the passing threshold of the matching number and the passing threshold of the matching degree may be determined according to user's preference. The present disclosure does not limit the threshold values.

The present disclosure also provides an apparatus for establishing association between devices. The apparatus may be any electronic device including, for example, notebook computers, desktop computers, mobile phones, or any suitable computing device. For example, the apparatus may include a processor and a processing circuit. The processor may include, for example, a central processing device (CPU), a microprocessor (MCU), a digital signal processor (DSP), a programmable array, an application processor (AP), etc. The processing circuit may include a specific integrated circuit or the like, capable of performing the above-described functions by executing predetermined commands/instructions/programs accordingly.

FIG. 2 illustrates a block diagram of an example of an apparatus for establishing association between devices according to some embodiments of the present disclosure. As shown in FIG. 2, the apparatus may include an acquisition device 201 and an association device 202. The acquisition device 201 obtains identity information of a current user. The identity information may include biological unique information. The association device 202 establishes an association with a mobile terminal that associates with the identity information after the identity information satisfies a pre-configured condition.

The association device 202 may include an acquisition sub-device and an association sub-device. The acquisition sub-device uses the identity information to obtain information of the mobile terminal associated with the identity information. The association sub-device uses the information of the mobile terminal to establish the association with the mobile terminal. The information of the mobile terminal associated with the identity information may include one or more of: information that unlocks the mobile terminal, information that allows the apparatus to access the mobile terminal, or information that establishes a connection with the mobile terminal.

The acquisition sub-device may further include a selection sub-device. The selection sub-device selects one or more of a plurality of mobile terminals associated with the identity information to establish the association. The association sub-device may further include a request sub-device and a return sub-device. The request sub-device sends association request information to the mobile terminal. The return sub-device receives association information returned from the mobile terminal, where the association information is in response to the association request information.

The pre-configured condition to be satisfied by the identity information may include one of the following two scenarios. In one scenario, the identity information is the same as a pre-stored identity verification information. In another scenario, a similarity that the identity information matches a pre-stored identity verification information satisfies a pre-configured identity verification condition.

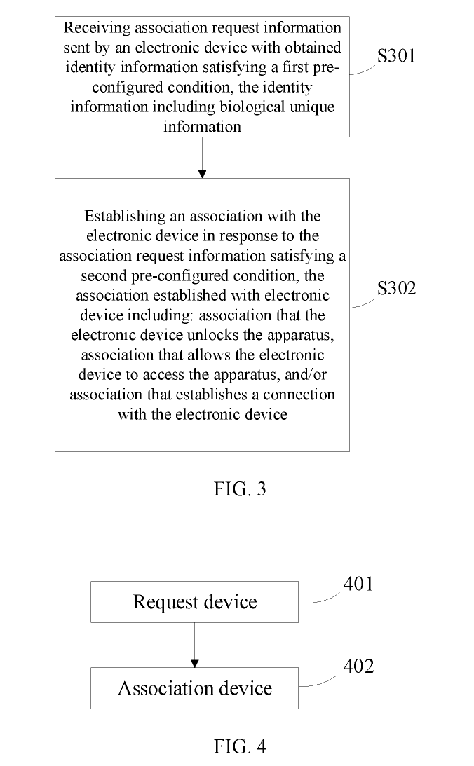

The present disclosure also provides another method for establishing association between devices. In some embodiments, the method may be implemented by a mobile terminal to establish an association with an electronic device such as a computer. The embodiments of the method described in FIG. 3 are intended to be illustrative, similar descriptions as described in other embodiments may not be repeated herein.

FIG. 3 illustrates a flow chart of another example of a method of establishing association between devices according to some embodiments of the present disclosure. As shown in FIG. 3, the method may include the following.

Association request information sent by an electronic device, having identity information satisfying a first pre-configured condition, is received (S301). The identity information may include biological unique information.

The identity information that satisfies the first pre-configured condition may be inputted in the electronic device. The electronic device may then send an association request to an apparatus, such as a mobile terminal.

The association request information may include one or more selected from: request information that unlocks the apparatus, request information that allows the electronic device to access to the apparatus, or request information that establishes a connection with the apparatus.

The receiving of the association request information sent by the electronic device whose identity information satisfies the first pre-configured condition may be equivalent to that the electronic device sends the association request to the apparatus.

An association with the electronic device is established in response to the association request information satisfying a second pre-configured condition (S302).

The association established with the electronic device may include one or more of: association that the electronic device unlocks the apparatus, association that allows the electronic device to access the apparatus, or association that establishes a connection with the electronic device.

For example, a mobile phone receives first request information that is sent by a notebook computer to establish a connection with the mobile phone. After the mobile phone confirms that the first request information satisfies a first requirement, the notebook computer may send second request information to the mobile phone to unlock the mobile phone. After the mobile phone confirms that the first request information satisfies a second requirement, the notebook computer may send third request information to the mobile phone to access the mobile phone. After the mobile phone confirms that the first request information satisfies a third requirement, the mobile phone may allow the notebook computer that sends a plurality of request information to access information of the mobile phone.

The present disclosure also provides another apparatus for establishing association between devices. Because the apparatus adopts similar method of establishing association between devices as previously described in the embodiments of the present disclosure, the description of the apparatus will be streamlined and may refer to the corresponding description of the previously disclosed embodiments for related parts. The embodiments of the apparatus described below are intended to be merely illustrative.

FIG. 4 illustrates a block diagram of another example of an apparatus for establishing association between devices according to some embodiments of the present disclosure. As shown in FIG. 4, the apparatus may include a request device 401 and an association device 402. The request device 401 receives association request information sent by an electronic device whose identity information satisfies a pre-configured condition. The identity information may include biological unique information. The association device 402 establishes an association with the electronic device in response to the association request information satisfying a pre-configured condition.

The association device 402 may include one or more of an unlocking sub-device 402-1, an open access sub-device 402-2, or a connection sub-device 402-3. The unlocking sub-device 402-1 unlocks the apparatus for the electronic device. The open access sub-device 402-2 opens access to information of the apparatus by the electron device. The connection sub-device 402-3 establishes a connection to the electronic device.

Based on the disclosure of the above embodiments, the embodiments of the present disclosure provide the following beneficial effects. The present disclosure provides a method and an apparatus for establishing association between devices. The method includes: obtaining identity information of a current user, where the identity information includes biological unique information; and when the identity information satisfies a pre-configured condition, establishing an association with a mobile terminal associated with the identity information. The disclosed method and apparatus solve the problem that a process of establishing a connection between a mobile terminal and a computer is cumbersome and error-prone.

It should be appreciated by those skilled in this art that the embodiments of the present disclosure may be provided in the form of a method, device (apparatus, system) or computer program product. Therefore, the embodiments of the present disclosure may be realized by complete hardware embodiments, complete software embodiments, or software-hardware combined embodiments. Moreover, the present disclosure may be realized in the form of a computer program product that is applied to one or more computer-usable storage devices (including, but not limited to disk memory, CD-ROM or optical memory) in which computer-usable program codes are contained.

The present disclosure is illustrated with reference to the flow chart and/or the block diagrams of the method, device (apparatus, system) and computer program product according to the embodiments of the present disclosure. It should be appreciated that each flow in the flow chart and/or each block in the block diagram and/or the combination of the flows in the flow chart and the blocks in the block diagram may be realized by computer program instructions. These computer program instructions may be provided to a general-purpose computer, a special purpose computer, an embedded processor or processors of other programmable data processing devices to generate a machine which makes the instructions executed by the processors of the computers, or the processors of other programmable data processing devices generate a device for realizing the functions specified in one or more flows of the flow chart or one or more blocks in the block diagram.

It should be understood that actions described in various methods of the present disclosure may be carried out in order as shown, or alternately, in a different order. Therefore, the order of the actions illustrated should not be construed as limiting the scope of the present disclosure. In addition, certain actions may be performed simultaneously.

In various embodiments, the disclosed device/devices can be configured in one device or configured in multiple devices as desired. The devices/devices disclosed herein can be integrated in one or multiple devices/devices. Each of them can be divided into one or more sub-devices/devices, which can be recombined in any manner. In addition, the devices/devices can be directly or indirectly coupled or otherwise communicated with each other, e.g., by suitable interfaces.

The coupling, or direct coupling, or communication connection between the disclosed components may use one or more interfaces. The indirect coupling or communication connection between devices or devices may be electrically, mechanically or in other suitable manner.

These computer program instructions may also be stored in a computer-readable memory which is capable of guiding a computer or another programmable data processing device to work in a given manner, thereby enabling the instructions stored in the computer-readable memory to generate a product including an instruction device for realizing the functions specified in one or more flows of the flow chart or one or more blocks in the block diagram. In one embodiment, the computer-readable memory includes a non-transitory computer-readable storage medium.

The computer program instructions may also be loaded to a computer or other programmable data processing devices to execute a series of operations thereon to generate the processing realized by the computer so that the instructions executed by the computer or other programmable data processing devices offer the steps for realizing the functions specified in one or more flows of the flow chart or one or more blocks in the block diagram, e.g., as described in the present disclosure.

In the present disclosure, relational terms such as first and second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the present specification are described in a progressive manner, in which each embodiment focusing on aspects different from other embodiments, and the same and similar parts of each embodiment may be referred to each other. Since the disclosed apparatus/device corresponds to the disclosed method, the description of the disclosed apparatus/device is made relatively simple, and may refer to the description of the methods in the present application.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present invention is not intended to be limited to the embodiments shown herein but is to be accorded the widest scope consistent with the principles and inventive features disclosed herein.

What is claimed is:

1. A method for establishing association between devices, comprising:
obtaining, by an apparatus, identity information of a current user, wherein the identity information includes biological unique information; and
in response to the identity information satisfying a pre-configured condition, establishing, by the apparatus, an association with a mobile terminal associated with the identity information.

2. The method according to claim 1, wherein establishing the association with the mobile terminal includes:
using the identity information to obtain information of the mobile terminal associated with the identity information; and
using the information of the mobile terminal to establish the association with the mobile terminal,
wherein the information of the mobile terminal associated with the identity information includes one or more of:
information that unlocks the mobile terminal;
information that allows the apparatus to access the mobile terminal; and
information that establishes a connection with the mobile terminal.

3. The method according to claim 2, wherein establishing the association with the mobile terminal further includes:
selecting at least one of a plurality of mobile terminals associated with the identity information to establish the association, wherein the at least one of the plurality of mobile terminals includes the mobile terminal.

4. The method according to claim 2, wherein using the information of the mobile terminal to establish the association with the mobile terminal includes:
sending association request information to the mobile terminal; and
receiving association information returned by the mobile terminal, wherein the association information is in response to the association request information.

5. The method according to claim 1, wherein the pre-configured condition includes one of following:
the identity information is a same as a pre-stored identity verification information; and
a similarity that the identity information matches the pre-stored identity verification information satisfies a pre-configured identity verification condition.

6. The method according to claim 1, wherein the mobile terminal:
receives an association request information sent by the apparatus; and
establishes an association with the apparatus such that:
the apparatus is able to unlock the mobile terminal;
the apparatus is allowed to access the mobile terminal; and
the mobile terminal establishes a connection with the apparatus.

7. An apparatus, comprising:
an acquisition device, for obtaining identity information of a current user, wherein the identity information includes biological unique information; and
an association device, for establishing an association with a mobile terminal associated with the identity information in response to the identity information satisfying a pre-configured condition.

8. The apparatus according to claim 7, wherein the association device further includes:
an acquisition sub-device that uses the identity information to obtain information of the mobile terminal associated with the identity information; and
an association sub-device that uses the information of the mobile terminal to establish the association with the mobile terminal,
wherein the information of the mobile terminal associated with the identity information includes one or more of:
information that unlocks the mobile terminal;
information that allows the apparatus to access the mobile terminal; and
information that establishes a connection with the mobile terminal.

9. The apparatus according to claim 8, wherein the acquisition sub-device further includes:
a selection sub-device acquisition that selects at least one of a plurality of mobile terminals associated with the identity information to establish the association, wherein the at least one of the plurality of mobile terminals includes the mobile terminal.

10. The apparatus according to claim 8, wherein the association sub-device further includes:
a request sub-device that sends association request information to the mobile terminal; and
a return sub-device that receives association information returned from the mobile terminal, wherein the association information is in response to the association request information.

11. The apparatus according to claim 7, wherein the pre-configured condition includes one of following:
the identity information is a same as a pre-stored identity verification information; and
a similarity that the identity information matches the pre-stored identity verification information satisfies a pre-configured identity verification condition.

12. The apparatus according to claim 7, comprising an electronic device, wherein the electronic device is a computer.

13. The apparatus according to claim 7, wherein the association device establishes the association with the mobile terminal and is capable of unlocking the mobile terminal and accessing the mobile terminal.
